(19) United States
(12) Patent Application Publication
(10) Pub. No.: US 2005/0236436 A1
(43) Pub. Date: Oct. 27, 2005

(54) Pressure chamber nozzle assembly

(75) Inventor: John R. Woods, Woodland Hills, CA (US)

Correspondence Address: Nicole S. Bradley;PILLSBURY WINTHROP LLP, Suite 2800, 725 South Figueroa Street, Los Angeles, CA, 90017, US

(73) Assignee: Spraytex, Inc., Valencia, CA (US)

(21) Appl. No.: 10/831,913

(22) Filed: Apr. 26, 2004

(51) Int. Cl. B67B 7/00; B65D 83/52

(52) U.S. Cl. 222/402.1; 239/390; 239/337

(57) ABSTRACT

A nozzle assembly is disclosed which provides for increased atomization, a finer spray, and a reduced tendency of the apparatus to clog. The nozzle assembly includes a pressure chamber through which the spray material must pass prior to exiting the spray container through a discharge orifice. As material exiting the container passes through the pressure chamber, pressure is built up, resulting in increased shearing and atomization of the spray material.

### FIELD OF INVENTION

This invention generally relates to a nozzle assembly for use with a spray can. More particularly, the invention relates to a nozzle assembly configured to induce additional pressure build-up so that the substance being sprayed is atomized to a higher degree, with a reduced incidence of clogging over other nozzles known in the art.

### BACKGROUND OF THE INVENTION

The practice of dispensing sprayable materials through traditional aerosol spray can valve assemblies has presented problems in that the nozzle on occasion may clog, particularly when the spray can is used infrequently. Additionally, in some instances, a greater degree of atomization may be desired for optimum functioning of the spray device. Furthermore, the practice of dispensing heavy and particulate materials through traditional aerosol spray can valve assemblies in the aerosol industry has presented problems in that the heavy and particulate materials to be dispersed have a tendency to clog up the valve assemblies. These heavy and particulate materials may include exterior stucco, heavy sand finishes, drywall and acoustic ceiling patching materials, fire suppressant materials, adhesive and bonding materials, and even culinary sauces.

As is well known in the art, traditional aerosol spray cans may be filled with material for dispensing. Similarly, a traditional aerosol spray can may be filled with heavy and particulate materials for spraying. However, because of the placement of the valve assembly in traditional aerosol spray cans, both traditional spray materials as well as the heavy and particulate materials will clog up the valve assemblies and render the aerosol spray cans inoperative. For example, constant operation of these aerosol spray cans in spraying heavy and particulate materials is not possible due to the inconsistent ability of these traditional valve assemblies to dispense these materials without clogging.

U.S. Pat. No. 5,715,975, issued to Stern et al., discloses an aerosol spray texturing device that is comprised of a container, a nozzle, a valve assembly, and an outlet. The valve assembly in the '975 patent is located in the upper section of the container near the nozzle. Although the nozzle tube of the device in the '975 patent may be configured to spray texture materials, the device in the '975 patent still has the problem of clogging or packing of the valve assembly by the particulates contained in the texture material for spraying, especially if the particulates are large, like those found in stucco or other heavy and particulate materials mentioned above.

U.S. Pat. No. 5,645,198, also to Stern, discloses a number of different ways in which texture material may be dispensed from a spray can to achieve a variety of different textures. The general concept is that such different textures may be achieved by varying the diameter of the outlet orifice. Such variation in diameter of the outlet orifice may be achieved, for example, (a) by using a plurality of different straws, each having a different internal diameter, (b) through use of a rotatable cap having a plurality of differently sized holes for outlet orifices, (c) through use of a deformable straw with a constricting sleeves or (d) through use of a deformable outlet passageway with a deformable rotating cap. Such variety in textures which being available from one can is highly desirable in the eye of the consumer.

Therefore, a long-standing need has existed to provide an apparatus that may be used to readily apply spray materials, including heavy and particulate materials, in aerosol form with increased atomization and without clogging of the nozzle. In some instances, it may further be desirable to spray such materials in more than one texture. Furthermore, such spray should be contained in a hand-held applicator so that the materials may be conveniently stored, as well as dispensed in a simple and convenient manner without clogging or packing the valve assembly of the applicator.

### BRIEF DESCRIPTION OF THE DRAWINGS

FIG. 1 is a front view of a pressure chamber valve assembly in accordance with one embodiment of the present invention;

FIG. 2 is a cross-sectional view of a pressure chamber valve assembly in accordance with the embodiment of the present invention shown in FIG. 1, taken along the “A-A” line of FIG. 1;

FIG. 3 is a side view of a pressure chamber valve assembly in accordance with one embodiment of the present invention; and

FIG. 4 is a perspective view of a spray device which incorporates the pressure chamber valve assembly in accordance with one embodiment of the present invention.

### DETAILED DESCRIPTION OF THE PREFERRED EMBODIMENTS

The present invention provides a valve assembly for use in an aerosol spray can which is configured to spray material with an increased pressure, an increased degree of atomization and reduced clogging over traditional valve assemblies known in the art. Such improved functionality stems from the inclusion of a pressure chamber in the dispensing assembly prior to the discharge opening. The nozzle assembly is capable of spraying a wide variety of different types of materials. Such materials include, but are not limited to, paints, resins, other liquids and viscous materials or materials with large particulates.

The present invention it provides an inexpensive and economical means for dispensing materials with an increased degree of atomization and a reduced incidence of clogging of the nozzle. Such reduced clogging is believed to be facilitated by the increased spray pressure and resulting atomization of the material which is being sprayed. Not only is the present invention easy to manufacture and assemble, but the reduced incidence of clogging results in increased user satisfaction and is expected to lead to a lower incidence of returns due to clogged nozzles.

When the present invention is used in association with known texture-modifying structures, it also provides an inexpensive and economical means for matching surface texture of a repaired or patched texture surface area. Since the spray-on hardenable texture material covers the repaired or patched area and visually assumes the surface texture of the surrounding patched or repaired surface, this results in the user seeing an improvement in the appearance of patched or repaired areas on a textured surface.

Aerosol assemblies are well known in the art. Generally, they comprise a container, a valve assembly, and an actuator member. As is also well known in the art, depressing the actuator member moves the valve assembly into its open position in which an exit passageway is defined from the interior of the container to the exterior of the container. This exit passageway generally terminates in a discharge opening formed in the actuator member.

The nozzle assembly according to the present invention uses many of the same elements as prior art nozzle assemblies, but additionally includes a pressure chamber in the exit passageway so that material exiting the container passes through the pressure chamber prior to exiting the system through the discharge orifice. The inclusion of the pressure chamber as part of the exit passageway allows for pressure buildup prior to the spray material's exit of the dispensing system.

The invention subjects the spray material to increased pressure prior to dispensing. This assists in shearing the material and provides increased atomization of the spray material. The increased pressure also leads to a reduced tendency for the nozzle to clog.

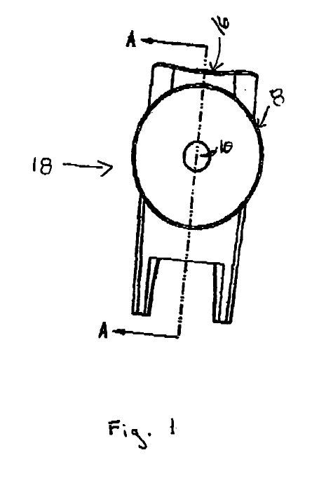

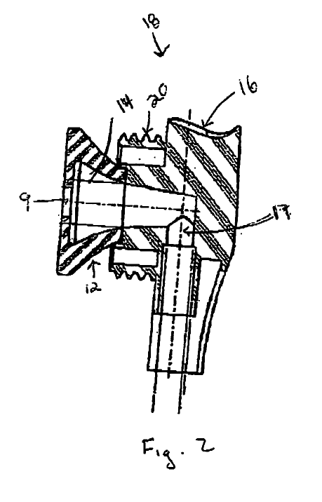

FIG. 1 is a front view of a valve assembly 18 in accordance with one embodiment of the present invention. This figure shows the variable nozzle 8 having a variable discharge opening 10 which is aligned with the pressure chamber 14 (not shown) exit orifice 11 (not shown), and the actuator 16. In use, the variable nozzle 8 is coupled to the valve assembly through a screw mechanism 17 (see FIG. 2). The user may tighten or loosen the variable nozzle 8 to enlarge or reduce the size of the variable discharge opening 10. That is, when the variable nozzle 8 is tightened, the rubber is pushed back and the variable discharge opening 10 is able to discharge more spray texture material, with less fine particles. In contrast, when the variable nozzle 8 is loosened, the rubber is relaxed, and the variable discharge opening 10 discharges less spray material, with finer particles. Thus, a smaller diameter variable discharge opening 10 results in a finer spray texture, while a larger diameter variable discharge opening results in a courser spray texture.

As discussed above, one of ordinary skill in the art will realize that the variable nozzle 8 is one of many features which may be added to permit the user to vary the resulting texture of the spray material being dispensed. Furthermore, such texture-varying means are not required to use the valve assembly according to the present invention.

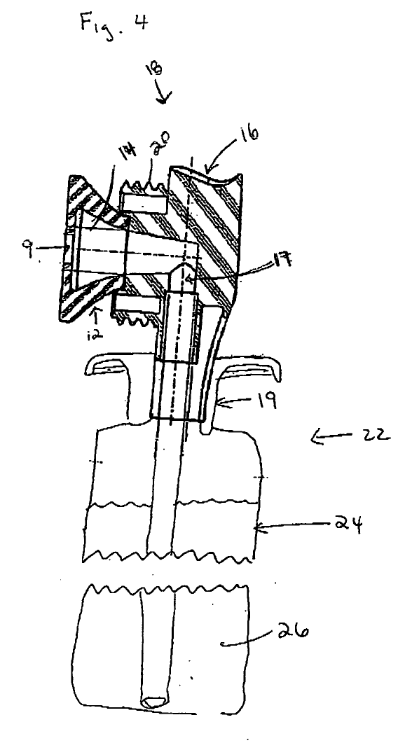

FIG. 2 is a cross-sectional view of a valve assembly 18 in accordance with the embodiment of the present invention shown in FIG. 1, taken along the “A-A” line of FIG. 1. As may be seen, this figure does not include the variable spray nozzle 8. The pressure chamber 14 is generally flared, with the flare starting back where the pressure chamber 14 is coupled to the vertical portion 17 of the discharge passageway. The vertical portion 17 of the discharge passageway comprises, at a minimum, a dip tube. The dip tube may be of sufficient length so as to extend into container 24 (See FIG. 4) and only along a portion of its height. Alternatively, the dip tube may extend to the bottom of the container 24.

As used herein, the term “discharge passageway” will refer to that structure or those structures through which the spray material passes en route from the holding container (not shown), through the pressure chamber discharge opening 9, to the variable discharge opening 10.

It will be realized by one of ordinary skill in the art that the pressure chamber may take a variety of different shapes. By way of example, and not of limitation, it may flare at a greater or lesser angle, it may be bulbous or it may be square or rectangular. Alternatively, the diameter of the discharge passageway may remain the same after it assumes a generally horizontal configuration, and may widen into the pressure chamber at some point subsequent to its turn to the horizontal configuration (that is, from a generally vertical to generally a horizontal configuration). However, such pressure chamber is preferably not elongated. From the above, one skilled in the art will be able to design a suitable pressure chamber and discharge opening if the spray apparatus is configured such that the discharge passageway does not undergo such a turn from a generally vertical position to a generally horizontal position.

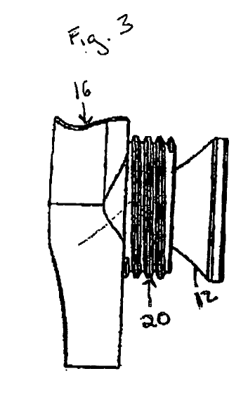

FIG. 3 is a side view of a valve assembly 18 in accordance with one embodiment of the present invention. This figure shows the exterior 12 of the pressure chamber 14, the actuator 16, and threads 20. As will be realized by one of ordinary skill in the art, such threads are simply one means through which a protective cap may be coupled to the present invention.

The valve assembly 18 is preferably generally formed from plastics using means readily known in the art. However, those of ordinary skill in the art will realize that it is possible to form the valve assembly 18, or portions thereof, from other materials including, but not limited to, resins or metals. Of course, if the valve assembly 18 is used in association with a variable nozzle 8, the variable discharge opening 10 will preferably be formed from rubber or other readily malleable material.

FIG. 4 is a perspective view of a spray device 22 which incorporates the pressure chamber valve assembly 18 in accordance with one embodiment of the present invention. As may be seen, the spray device 22 generally includes a valve assembly 18, a bushing 19, a container 24 and spray material 26.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1. An aerosol system comprising a container, a sprayable material and a valve assembly that sprays the sprayable material from the container, wherein the valve assembly comprises:
a dip tube with a top opening and a bottom opening, wherein the dip tube is at least primarily disposed inside the container;
an actuator coupled to the top end of the dip tube, the actuator being configured to move from a first position to a second position;
a pressure chamber configured to be in flowable communication with the dip tube when the actuator is in the second position, wherein sprayable material is dispensed through the discharge opening when the actuator is in the second position; and
a discharge opening in flowable communication with the pressure chamber, the discharge opening having a diameter that is smaller than a diameter of the pressure chamber.

2. The aerosol system as in claim 1, wherein the pressure chamber flares to a diameter that is larger than the diameter of the dip tube.

3. The aerosol system as in claim 1, wherein the pressure chamber defines a shape selected from the group consisting of bulbous, flared, square and rectangular.

4. The aerosol system as in claim 1, wherein a diameter of the discharge opening may be changed by a user.

5. An aerosol system comprising a container, a sprayable material and a valve assembly that sprays the sprayable material from the container, wherein the valve assembly comprises:
a dip tube with a top opening and a bottom opening, wherein the dip tube is at least primarily disposed inside the container,
an actuator with an aperture forming a discharge opening coupled to the top end of the dip tube, the actuator being configured to move from a first position to a second position;
a pressure chamber configured to be in flowable communication with the dip tube and the discharge opening when the actuator is in the second position, wherein the discharge opening has a diameter that is smaller than a diameter of the pressure chamber.

6. The aerosol system as in claim 5, wherein the pressure chamber flares to a diameter that is larger than the diameter of the dip tube.

7. The aerosol system as in claim 5, wherein the pressure chamber defines a shape selected from the group consisting of bulbous, flared, square and rectangular.

8. The aerosol system as in claim 5, wherein a diameter of the discharge opening may be changed by a user.

9. A valve assembly for spraying viscous or particulate material, the assembly comprising:
a dip tube with a top opening and a bottom opening, wherein the bottom opening is configured to be in flowable communication with the viscous or particulate material;
an actuator coupled to the top end of the dip tube, the actuator being configured to move from a first position to a second position;
a pressure chamber configured to be in flowable communication with the top opening when the actuator is in the second position; and
a discharge opening in flowable communication with the pressure chamber, the discharge opening having a diameter that is smaller than a diameter of the pressure chamber, wherein sprayable material is dispensed through the discharge opening when the actuator is in the second position

10. The aerosol system as in claim 9, wherein the pressure chamber flares to a diameter that is larger than the diameter of the dip tube.

11. The aerosol system as in claim 9, wherein the pressure chamber defines a shape selected from the group consisting of bulbous, flared, square and rectangular.

12. The aerosol system as in claim 9, wherein a diameter of the discharge opening may be changed by a user.

13. A method of applying a sprayable material onto a surface area, the method comprising the steps of:
storing the sprayable material in a fluid-tight aerosol dispensing container having a valve assembly for application to the surface area, wherein the valve assembly comprises:
a dip tube with a top opening and a bottom opening, wherein the bottom opening is configured to be in flowable communication with the sprayable material;
an actuator coupled to the top end of the dip tube, the actuator being configured to move from a first position to a second position;
a pressure chamber configured to be in flowable communication with the top opening when the actuator is in the second position; and
a discharge opening in flowable communication with the pressure chamber, the discharge opening having a diameter that is smaller than a diameter of the pressure chamber, wherein sprayable material is dispensed through the discharge opening when the actuator is in the second position; and
selectively dispensing the sprayable material onto the surface area such that the sprayable material forms a layer of sprayable material.

14. The method of applying sprayable material as in claim 13, wherein the pressure chamber flares to a diameter that is larger than the diameter of the dip tube.

15. The method of applying sprayable material as in claim 13, wherein the pressure chamber defines a shape selected from the group consisting of bulbous, flared, square and rectangular.

16. The method of applying sprayable material as in claim 13, wherein a diameter of the discharge opening may be changed by a user.

17. The method of applying sprayable material as in claim 13, wherein the sprayable material forms a layer having an irregular surface texture.
